(19) United States
(12) Patent Application Publication
(10) Pub. No.: US 2008/0130105 A1
(43) Pub. Date: Jun. 5, 2008

(54) Microscope With a Slider

(76) Inventor: Matthias Gonschor, Gleichen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/664,783

(22) PCT Filed: Sep. 28, 2005
(86) PCT No.: PCT/EP05/10475

§ 371 Date: Apr. 5, 2007

(30) Foreign Application Priority Data
Oct. 5, 2004 (DE) 10 2004 049 275.1

(51) Int. Cl. G02B 21/24

(52) U.S. Cl. 359/388

(57) ABSTRACT

The invention is directed to a microscope with a slider for introducing optical elements into the beam path of the microscope. This slider has a holder for a plurality of optical elements and an actuation element by which the optical elements can be moved into the beam path.

### CROSS-REFERENCE TO RELATED APPLICATIONS

This application claims priority of International Application No. PCT/EP2005/010475, filed Sep. 28, 2005 and German Application No. 10 2004 049 275.1, filed Oct. 5, 2004, the complete disclosures of which are hereby incorporated by reference.

### BACKGROUND OF THE INVENTION

a) Field of the Invention

The present invention relates to a microscope with a slider.

b) Description of the Related Art

In microscopy, it is necessary for certain microscope methods to introduce special optical elements such as filters, pupil modulator elements, diaphragms, contrast modulators or the like in “special” planes such as the field diaphragm plane, the aperture diaphragm plane, and so on.

For this purpose, the microscopes have suitable openings at corresponding locations in the housing and guides by means of which the user can introduce various optical elements into the beam path when needed. To ensure simple and reliable placement and universality, these guides are standardized with respect to size and geometric dimensioning by the particular microscope manufacturers.

Examples for the application and construction of sliders of this kind can be found, for example, in U.S. Pat. No. 6,437,912. Sliders each having an optical element which they can move into the beam path of the microscope are previously known from the prior art described in this reference. In order to avoid the need for frequent changing of the whole slider when changing the microscope method, this reference proposes using a slider with two passages for the beam path and placing optical elements in each of these passages so that it is possible to change between these optical elements by changing the position of the slider.

In a further development of the above-mentioned idea, DE 103 56 197 proposes arranging more than three passages along the axis of the slider and arranging an optical element (in this case, phase contrast rings) in each of these passages. Again, it is necessary to change the position of the slider in order to change between these elements. In order to select the various positions, this slider has a corresponding quantity of notches which ensure, in cooperation with a catch, that the respective phase ring is correctly positioned in the beam path. This apparatus requires considerable skill on the part of the user because the distances between the individual catch positions differ and, therefore, different distances must be traversed for changing. Further, the number of possible optical elements is limited due to the limited length of the slider.

### OBJECT AND SUMMARY OF THE INVENTION

It is the primary object of the invention to overcome the disadvantages of the prior art and to provide a slider which makes it possible to introduce a plurality of optical elements into the beam path of microscopes in a simple manner.

This object is met by a microscope comprising at least one slider for introducing optically active elements into the beam path of the microscope in a defined manner. The slider has a base body which can be introduced into an opening in the housing of the microscope. The slider has at least one passage for the beam path and a holder for at least two optical elements. Means are provided so that the holder is movable in such a way that one of the optical elements can be introduced into the beam path of the microscope.

It is particularly advantageous when the slider has at least one holder for optical elements and at least one passage, and the holder has a device for positioning one of the optical elements in the beam path of the microscope.

The holder can be movable substantially linearly for changing between the optical elements. It is particularly advantageous when the holder is substantially wheel-shaped and the optical elements are arranged on the circumference of the holder. In this case, the positioning of the optical elements is carried out by rotating the holder.

According to the invention, the holder can be actuated by a manual actuation element such as a lever, a rotary knob, a handwheel, or the like, or actuation of the holder can be carried out by a motor.

In a further construction of the invention, the slider is outfitted with a second, or more, holder(s) to increase the number of optical elements that can be inserted into the beam path. The additional holders can be arranged in such a way that they share the same passage for the beam path of the microscope. But it is also possible to provide additional passages. In that case it would be necessary to displace the slider in order to move one of these additional passages into the beam path. The person skilled in the art is familiar with a displacement of this kind for inserting another passage into the beam path from the prior art (DE 103 56 197).

Possible optical elements include all elements known in microscopy for manipulating the beam path. Examples include color filters, neutral filters, diffusers, phase modulators, gratings, contrast modulators, phase rings, diaphragms, and so on.

In a particularly advantageous solution, the optical elements are diffusers or diffuser combinations of various transmissions and the slider is positioned in the aperture diaphragm plane. In this case, the intensity of the beam impinging on the object can be regulated in a simple manner without having to change the lamp voltage, which generally always brings about an unwanted change in the color temperature.

Further, the diffusers can also be used advantageously in connection with mercury high-pressure lamps. In contrast to conventional interference gray filters, they are not subject to wear.

Moreover, by combining with the diffusing effect the illumination of the object field is homogenized.

It is also possible to provide means by which the optical elements can be aligned relative to the holder and, therefore, relative to the beam path. Such devices are known, for example, from DE 102 58 988.

The invention will be described more fully in the following with reference to the drawings.

### BRIEF DESCRIPTION OF THE DRAWINGS

In the drawings:

FIG. 1 is a schematic view of the beam path in a microscope;

FIG. 2 shows a view of a first embodiment form of the invention; and

FIGS. 3 and 4 are schematic views of a second and third embodiment form of the invention.

### DESCRIPTION OF THE PREFERRED EMBODIMENTS

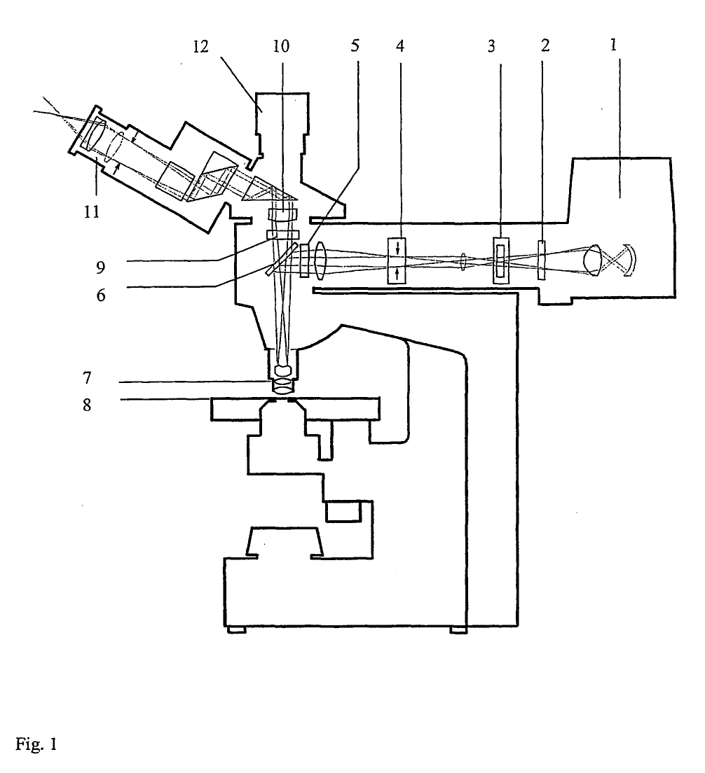

The entire beam path in a microscope is shown schematically in FIG. 1. The light coming from a light source 1 is directed through a heat protection filter 2, the aperture diaphragm 3, and the field diaphragm 4 to the excitation filter 5. The splitter mirror 6 reflects the excitation light via the objective 6 onto the object 8. The fluorescent light generated in the object 8 by the excitation light passes in turn through the objective 7 and is now passed by the splitter mirror 6 and imaged through the emission filter 9 onto the tube lens 10 and from the latter via a prism system into the eyepieces 11.

Alternatively, the light can also be imaged by means of a camera arranged at the phototube 12.

At the location of the aperture diaphragm 3 and field diaphragm 4, the microscope housing has openings for inserting optical elements into the beam path by means of sliders.

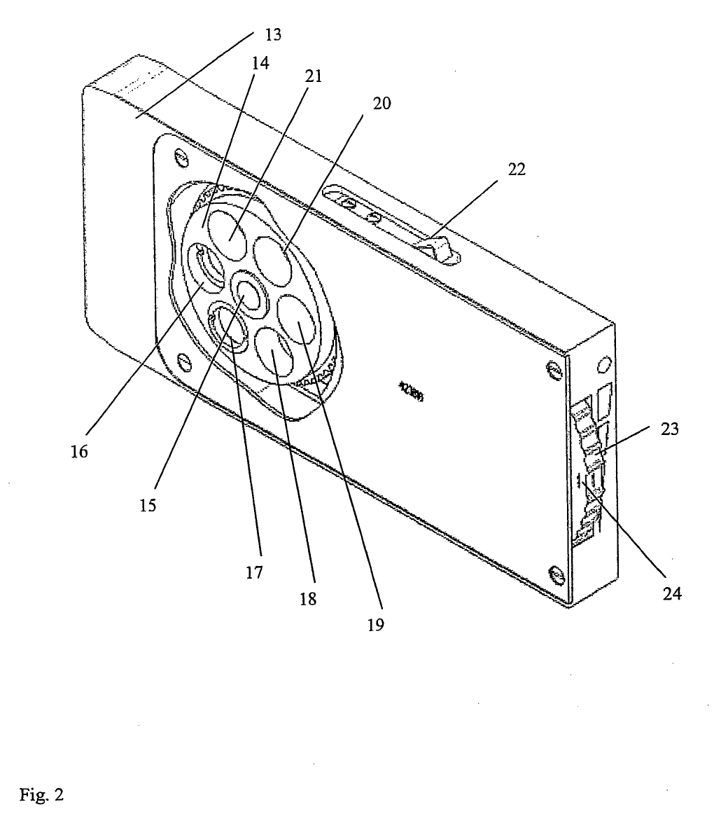

FIG. 2 shows a view of a slider according to a preferred embodiment form of the invention. The slider 13 carries a holder 14 which is rotatable around an axis 15 and which has receptacles 16, 17, 18, 19, 20, 21 for optical elements, not shown, such as diaphragms, filters, or the like.

For the sake of clarity, the housing of the slider is shown with one opening. In reality, only a passage is provided at the location where the receptacle 16 is located. The rest of the holder 14 is concealed by the housing.

The slider 13 has a catch 22 which ensures the correct positioning of the slider in relation to the beam path of the microscope.

A knurled wheel 23 serving as an actuation element for the holder 14 is arranged at the slider 13 in such a way that it can be operated by the user from the outside when the slider 13 is inserted. For the user's information, the knurled wheel has an indicator 24 for the number or designation of the optical element currently inserted in the beam path.

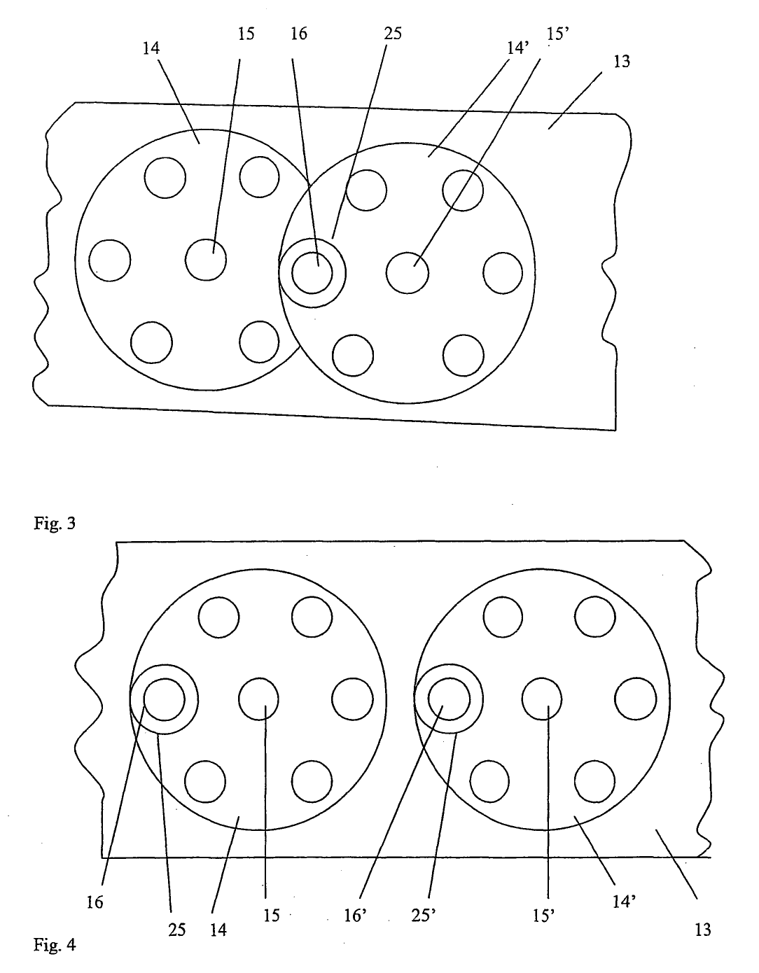

Further embodiment forms of the invention are shown schematically in FIGS. 3 and 4. The slider 13 has two holders 14, 14′ with receptacles for optical elements which are rotatable around axes 15, 15′.

In FIG. 3, the holders 14, 14′ are arranged relative to one another in such a way that the optical elements can be positioned in a shared passage 25 for the beam path of the microscope. Each holder 14, 14′ has a free position so that the optical elements can be inserted into the beam path independent from one another. With six receptacles for optical elements per holder, a total of ten elements can be inserted into the beam path so that the inventive solution is much more versatile than previously known solutions.

In case the slider is used for regulating brightness and neutral filters or diffusers of different transparency are accordingly used as optical elements, it is also possible to achieve a more sensitive gradation by combining optical elements from the two holders. For example, an optimum brightness for observation and camera recording can always be adjusted with filters of 100%, 50%, 25%, 12% and 6% transparency in holder 14 and with filters of 100%, 6%, 1.5% and 0.4% transparency in holder 14′.

In FIG. 4, each holder 14, 14′ has its own free passage 25, 25′ so that with six receptacles per holder a total of 12 different optical elements can be introduced into the beam path.

In another embodiment form of the invention, the optical elements are arranged on a holder next to one another so that a linear movement of the holder is carried out for introducing the optical elements into the beam path. A movement of this kind can be motorized in a simple manner and accordingly likewise leads to an appreciable improvement over the prior art.

The invention was described with reference to an upright microscope, but can also be used in an inverted microscope.

The invention is not limited to the preferred embodiment examples shown herein. Further technical developments do not constitute a departure from the protective scope defined by the claims.

While the foregoing description and drawings represent the present invention, it will be obvious to those skilled in the art that various changes may be made therein without departing from the true spirit and scope of the present invention.

1-10. (canceled)

11. A microscope comprising:
at least one slider for introducing optically active elements into the beam path of the microscope in a defined manner;
said microscope having a housing;
said slider having a base body which can be introduced into an opening in the housing of the microscope;
said slider having at least one passage for the beam path of the microscope and a holder for at least two optical elements; and
means being provided so that the holder is moveable in such a way that one of the optical elements can be introduced into the beam path of the microscope.

12. The microscope with at least one slider according to claim 11, wherein the holder carries out a substantially linear movement for introducing the optical elements into the beam path.

13. The microscope with at least one slider according to claim 11, wherein the holder carries out a substantially rotational movement for introducing the optical elements into the beam path.

14. The microscope with at least one slider according to claim 11, wherein the slider has an actuation element for the changing movement of the holder.

15. The microscope with at least one slider according to claim 11, wherein the slider has an indicator for showing the current position of the holder.

16. The microscope with at least one slider according to claim 11, wherein the slider has at least one additional holder for additional optical elements by means of which these additional optical elements can be introduced into the beam path of the microscope.

17. The microscope with at least one slider according to claim 16, wherein the additional optical elements can be introduced into the same passage for the beam path of the microscope.

18. The microscope with at least one slider according to claim 16, wherein an additional passage is provided for the optical beam path in which the additional optical elements can be introduced.

19. The microscope with at least one slider according to claim 11, wherein the movement of the holder is carried out by motor.

20. The microscope with at least one slider according to claims 16, wherein one or more of the following are provided as optical elements: color filters, neutral filters, diffusers, phase modulators, gratings, contrast modulators, phase rings, diaphragms.
